(19) United States
(12) Patent Application Publication
(10) Pub. No.: US 2026/0286756 A1
(43) Pub. Date: Sep. 24, 2026

(54) GUIDING DEVICE, GUIDE CARRIAGE AND FUNCTIONAL ENTITY

(71) Applicant: HAWA SLIDING SOLUTIONS AG, Mettmenstetten (CH)

(72) Inventors: Flavio PALOMBELLA, Zug (CH); Marco TUBERGA, Hedingen (CN)

(73) Assignee: HAWA SLIDING SOLUTIONS AG, Mettmenstetten (CH)

(21) Appl. No.: 19/474,411

(22) PCT Filed: Apr. 26, 2024
(86) PCT No.: PCT/EP2024/061603

§ 371 Date: Oct. 10, 2025

(30) Foreign Application Priority Data
May 5, 2023 (EP) 23171916.2

(51) Int. Cl. E05D 15/58; E05D 15/26

(52) U.S. Cl. CPC E05D 15/58; E05D 15/266; E05D 2015/586; E05Y 2201/22; E05Y 2201/64; E05Y 2201/692; E05Y 2600/51; E05Y 2600/528; E05Y 2600/63; E05Y 2900/212

(57) ABSTRACT

The guiding device includes a guide carriage including carriage body and coupling device connected thereto, and connection device including a rotatably mounted hinge element connectable to a separation element, and couplable to the guide carriage. The carriage body includes a sledge bearing and holds a lever shaft. The coupling device includes coupling lever having an end piece rotatably supported by the lever shaft and front piece(s) with locking member and receiving member for a coupling rod, and a holding sledge displaceably held by the sledge bearing connected to the carriage body by reset spring(s) and sledge front piece(s) with retaining hook. The coupling lever is dimensioned so that when rotating the coupling lever into a locking position, the holding sledge is displaceable by interaction of the locking shape of the locking member and the retaining shape of the retaining hook and the coupling lever is lockable by the retaining hook.

The invention relates to a guiding device comprising a guide carriage which has a coupling device and which is connectable by a connection device to a separation element of a functional entity. Furthermore, the invention relates to such a guide carriage and to a functional entity such as a piece of furniture provided with such a guiding device.

Partition elements, possibly foldable partition elements such as folding doors or foldable sliding doors, are used to close off functional units, such as openings in rooms or pieces of furniture. Preferably, partition elements are provided that are moved into a door compartment after the opening has been released so as not to be obtrusive.

U.S. Pat. No. 9,284,761B2 discloses a piece of furniture with a displacement device by means of which a mounting profile connected to a foldable sliding door is displaceable within a door compartment. The foldable sliding door comprises two door elements, of which the first door element is connected at the rear by mounting hinges to the mounting profile and at the front to the rear of a second door element. The second door element is connected at the front by a connection device to a guide carriage of a guiding device, which is slidably mounted in a guide rail. The connection device comprises a hinge with a hinge lever, which is rotatably connected to a hinge cup with a first lever end piece and can be connected to the carriage body of the guide carriage with a second lever end piece. The first end piece comprises a receiving sleeve into which a hinge shaft is inserted. The second lever end piece comprises a lever block with a threaded hole into which a mounting bolt is screwed, which can be hooked into the carriage body of the guide carriage. Connecting the foldable sliding door to the guide carriage by hooking the mounting bolt of the connection device into the carriage body of the guide carriage cannot be performed easily and requires skill.

US2020018106A1, US2021262266A1 and US2022307305A1 disclose further guiding devices with a guide carriage which has a coupling device to which a connection device can be coupled, which can be connected to a separation element by a rotatably mounted hinge part.

The coupling device of the guide carriage of US2020018106A1 comprises a carrier which has an upper and a lower support element. The connection device which is connected to a door has hooks on the upper side and the lower side which can be hooked into the support elements.

The coupling device of the guide carriage of US2021262266A1 also comprises a carrier which has an upper and a lower support element. The connection device which is connected to a door has hooks on the upper side which can be hooked into the upper support element. On the underside, the connection device has a locking device that can be connected to the lower support element.

It is also not easy to attach the door to the guide carriage with these connection devices, as the connection device must first be attached to the upper support element and then, if necessary, by rotating the door element, also connected to the lower support element. The guide carriage with the coupling device and the connection device are also relatively complex in design and take up a relatively large amount of space.

The coupling device of the guide carriage of US2022307305A1 comprises a carrier which has an upper and a lower support element, into which in turn a connection device can be hooked. The support elements are held by a locking element which has a locking member with a locking shape and which is rotatably and displaceably mounted. The locking element can be rotated outwards with the upper bearing element, which allows the connection device, which comprises a locking bolt, to be hooked in more conveniently. Once the connection device connected to the door has been hooked in, the locking element is turned back. During this process, the locking bolt is engaged in the locking shape. The rotatable and displaceable mounting of the locking element and the additional arrangement of a locking bolt and a locking shape in turn lead to a relatively complex design of this device, which in turn takes up a relatively large amount of space.

The coupling devices of the guide carriages of US2020018106A1, US2021262266A1 and US2022307305A1 each comprise a carrier which is connected by a horizontally aligned connecting web to the part of the carriage body of the guide carriages which holds the support rollers and guide rollers. The coupling device with the carrier is therefore spaced apart from the guide carriage by the connecting web, for which reason the guide carriage with the coupling device takes up a particularly large amount of space.

It should further be noted that the coupling devices and connecting devices of US2020018106A1, US2021262266A1 and US2022307305A1 comprise numerous manufacturer-specific device parts which must be robustly designed regarding the load to be carried by the separation element. The manufacture and assembly of this device is therefore correspondingly complex.

The use of conventional hinges, which have a simple hinge lever, is also impossible or almost impossible to realise with these connecting devices. These devices also lack the option of easily adjusting the height of the door element connected to the guide carriage.

The present invention is therefore based on the object of creating an improved guiding device with an improved guide carriage comprising a coupling device which is connectable to a connection device mounted on a separation element. Furthermore, a functional entity with such a guiding device and such a guide carriage shall be created.

The inventive guiding device shall allow a separation element, particularly a sliding door, to be detachably connected in a simple manner by means of a connection device to a guide carriage which comprises a coupling device and which is slidably mounted in a guide rail. During this process, it shall be possible to connect the separation element to the guide carriage without having to rotate or tilt it. The process of connecting and disconnecting the separation element shall be easy to perform.

The guide carriage, which comprises at least one support roller and preferably at least one guide roller and/or at least one stabilisation roller, shall be of simple and robust construction and shall have a coupling device which takes up little space and which scarcely projects from the carriage body. A carrier that is connected to the carriage body by a connecting bar should be avoided if possible. The carriage body and the coupling device shall be practically one unit, at least after the connection device has been coupled, so that the coupling device results in only a minimal increase in the guide carriage.

The connection device, which is connectable to the separation element by means of a hinge, should also have a simple, compact and robust design so that it takes up very little space. The connection device and the coupling device shall be able to connect conventional hinges to the guide carriage in a simple manner.

Device parts that perform complex movements, such as a rotation in combination with a displacement, and are correspondingly complex to realise and support, shall be avoided.

Furthermore, it shall be possible to construct the connection device and the coupling device with as few device parts as possible, so that the manufacturing costs and the space requirement can be reduced. Despite the small amount of space required, the device parts should also be stable so that deformation is avoided, particularly when assembling heavier separating elements. The guiding device shall require hardly any maintenance even after prolonged operation.

The guiding device shall preferably allow to easily adjust the held separation element especially its height.

Furthermore, the guide carriage shall be easily adaptable to any running rails or guide rails.

This task is solved by a guiding device according to claim 1, a guide carriage according to claim 14 and a functional entity, optionally a piece of furniture, according to claim 15. Advantageous embodiments of the invention are specified in further claims.

The guiding device comprises a guide carriage, which has a carriage body and a coupling device connected to the carriage body, a guide rail, in which the guide carriage is displaceably mounted, and a connection device, which comprises a rotatably mounted hinge element, which is connectable to a separation element, and which is couplable to the guide carriage by the coupling device.

According to the invention
the connection device comprises a hinge lever having a hinge lever end piece connected to the hinge element and a hinge lever front piece holding a coupling rod,
the carriage body comprises a sledge bearing and holds a lever shaft,
the coupling device comprises a coupling lever having a coupling lever end piece rotatably supported by the lever shaft and at least one coupling lever front piece having a locking member and a receiving member, which receiving member serves to receive and hold the coupling rod,
the coupling device comprises a holding sledge, which is displaceably held by the sledge bearing, which is connected to the carriage body by at least one reset spring and which has at least one sledge front piece with a retaining hook,
the locking member has a locking shape and the retaining hook has a retaining shape, and
the coupling lever is dimensioned in such a way that when rotating the coupling lever into a locking position, the holding sledge is displaceable by interaction of the locking shape and the retaining shape and the coupling lever is lockable by the retaining hook.

The coupling lever can therefore be rotated between a receiving position, in which it preferably rests against a stop element, preferably against a part of the carriage body, into a locking position and locked there by the holding sledge. The locking shape and the retaining shape are designed in such a way that the coupling lever end piece can displace the associated retaining hook and, upon further rotation, engage behind the retaining hook, which during this process is pushed back again by the at least one reset spring.

By moving the holding sledge, the at least one coupling lever end piece can be released again from the associated retaining hook and the coupling lever can be rotated back into the receiving position. By means of a corresponding embodiment of the locking shape and the retaining shape, it can be provided that the coupling lever end piece can displace the locking hook upwards when the coupling lever is rotated forwards and backwards under the effect of force to lock the coupling lever and release it again. For this purpose, the locking shape and the retaining shape are preferably rounded or provided with corresponding flanks so that they allow the coupling lever to rotate in both directions when force is applied. The coupling lever end piece can therefore be brought into a force-fit connection with the retaining hook and released again from the force-fit connection with the retaining hook by applying pressure or pulling on the coupling lever. Direct access to the holding sledge is not necessary.

However, if the locking shape and the retaining shape can be interlocked form-fittingly in such a way that a blockage results after the coupling lever end piece has engaged, the coupling lever is released, for example by manually moving the holding sledge and releasing the retaining hook from the coupling lever end piece.

To connect a separation element, for example a door element, to the guide carriage, the hinge part of the connection device is first connected to the separation element. Then, by lifting the separation element, the coupling rod of the connection device is hooked into the receiving member of the coupling lever. After this process, the separation element is already held by the guide carriage, which is why a simple application of force to the separation element moves it against the guide carriage and turns the coupling lever into the locking position, in which the coupling rod is caught and held by the retaining hook.

The guide carriage can be designed to be slim by providing that the holding sledge lies directly against the carriage body and only the retaining hook is exposed and accessible for the coupling lever. The holding sledge therefore preferably only protrudes a few millimetres from the carriage body. The thickness of the coupling lever preferably corresponds to the dimensions of the retaining hook, so that the holding sledge and the coupling lever lie directly against the carriage body in the locked position and take up practically no space. In the locking position, the carriage body, the coupling lever and the holding sledge form practically one unit, which differs only slightly from the dimensions of the carriage body.

In a preferred embodiment, it is provided that the coupling lever comprises two lever arms spaced apart from each other, each with a coupling lever front piece comprising a locking member and a receiving member, and that the distance between the lever arms is greater than the width of the carriage body. The coupling lever therefore preferably has a U-profile, the side arms of which are formed by the lever arms, which preferably engage laterally around the carriage body without play and can preferably each co-operate with a retaining hook of the holding sledge. The coupling lever and the holding sledge are therefore preferably in contact with the carriage body without play, at least in the locking position, but can be rotated or moved relative to it.

A device part that performs complex movements and, for example, is held rotatably and displaceably, as well as corresponding expenses for the complex mounting of this device part, are avoided.

The holding sledge preferably comprises two spaced-apart sledge arms, each with a retaining hook and thus preferably also a U-profile, which surrounds the carriage body on both sides, preferably closely adjoining it. In this preferred embodiment, the coupling lever and the holding sledge thus embrace the carriage body on both sides from different directions but on the same sides of the carriage body, on which they or the locking shapes and the retaining shapes can interact.

In the locking position, the coupling lever and the holding sledge form a unit by means of a force-fit connection, which partially encloses the carriage body and is held stable by it.

In the locking position, the single part or two-part coupling rod of the connection device is held by the coupling lever and preferably aligned perpendicular to the hinge axis. For relieving the coupling lever in the locking position, the carriage body is preferably provided with at least one latching sink, into which the coupling rod can preferably be inserted in such a way that the load acting via the coupling rod does not act on the coupling lever but on the carriage body. The latching sink is preferably provided with an entrance shape via which the coupling rod can be inserted into the latching sink.

The load acting on the coupling rod is therefore transferred from the coupling lever to the carriage body as the coupling lever rotates, so that the coupling lever is not loaded in the locking position and merely ensures that the coupling rod remains held in the latching sink. For this purpose, the coupling lever front piece is preferably fork-shaped, with the receiving member being limited on the one hand by the locking member and on the other hand by a holding member.

When the coupling lever is rotated into the locking position, the held coupling rod can therefore be inserted into the latching sink and the holding sledge can be displaced by interaction of the locking shape and the retaining shape and the coupling lever can be locked by the retaining hook.

To ensure that the load of the coupling rod is transferred to the carriage body, the latching sink is preferably slightly higher than the receiving member of the coupling lever. The coupling lever therefore transfers the coupling rod into the latching sink and is subsequently relieved.

In a preferred embodiment, the sledge end piece is provided with at least one holding element which, after insertion of the holding sledge into the sledge bearing and after insertion of the lever shaft, rests against the lever shaft and prevents the holding sledge from coming loose from the sledge bearing. The lever shaft therefore has a dual function and serves for the rotatable holding of the coupling lever on the one hand and as a stop for the holding sledge on the other. In this way, the guide carriage can be manufactured in a particularly compact and cost-effective manner.

In a further preferable embodiment, the carriage body comprises a reception chamber into which the hinge lever front piece is preferably form-fittingly received when the connection device is coupled. In this embodiment, the hinge lever is held rigidly by the guide carriage after coupling to the guide carriage. Alternatively or additionally, it is also possible to fix the hinge lever front piece by means of screws and, if necessary, to adjust it and rotate it laterally as required.

In preferred embodiments, the carriage body comprises two latching sinks that serve for receiving the coupling rod. For this purpose, the preferably provided reception chamber comprises, for example, two side walls adjoining the carriage body, which are spaced apart from one another and in each of which one of the latching sinks is provided.

The coupling rod, which is designed in one or more parts, protrudes with both end pieces from the hinge lever front piece and can be hooked with both end pieces into the coupling lever front piece of the coupling lever and each transferred into a latching sink of the carriage body.

The sledge arms of the holding sledge are preferably provided with sledge runners directed towards each other. The sledge bearing is preferably designed as a guide profile comprising guide grooves running parallel to each other on both sides, into which the sledge runners engage. The holding sledge connected to the guide profile can therefore only be moved axially upwards or downwards, for example against the lever shaft. The upward displacement takes place under the influence of the coupling lever. The downward displacement takes place under the influence of the at least one reset spring, which can be of any design and is, for example, a return spring or a recoil spring.

Preferably, two reset springs are provided, which are arranged at the front of the carriage arms and are preferably each inserted into a reception seat. The reset springs are preferably designed as coil springs. However, other springs, such as leaf springs or any tension springs, can also be used.

In a further preferred embodiment, it is provided that the hinge lever front piece comprises a lever chamber in which the coupling rod is held by an adjustment device so as to be displaceable or adjustable, particularly parallel to the hinge shaft, so that the held separation element can be raised or lowered relative to the guide carriage.

The threaded rod is guided through a threaded hole in a bearing block that holds the coupling rod. By turning the threaded rod, the bearing block with the coupling rod can be moved upwards and downwards.

The threaded rod, which preferably comprises a bearing shoulder, preferably comprises on one end or both ends a tool connection for a tool by means of which the threaded rod can be rotated.

The lever chamber preferably has a lower access opening and an upper access opening through which a tool can be passed and inserted into the tool connection. If necessary, one of the access openings also serves for bearing the threaded rod.

The coupling rod is designed in one or two parts and preferably protrudes on one side from a first chamber opening and on the other side from a second chamber opening of the lever chamber.

For example, the lever chamber comprises a larger chamber opening through which the adjustment device with the threaded rod, the bearing block and the coupling rod can be inserted into the lever chamber.

For mounting in the guide rail, the guide carriage can be of any design and be provided with any running elements and/or guide elements, in particular support rollers and/or guide rollers and/or stabilising rollers or with corresponding sliding elements.

Preferably, the guide carriage comprises at least one support roller and at least one guide roller and/or at least one stabilisation roller.

The guiding device and the guide carriage can be connected to any single-part or multi-part separating elements, such as foldable sliding doors.

The guiding device can also be installed in any functional units, such as furniture, wardrobes and the like, which comprise a rotatable or movable or rotatable and movable single-part or multi-part separation element.

The invention is explained in more detail below with reference to the drawings. It shows:

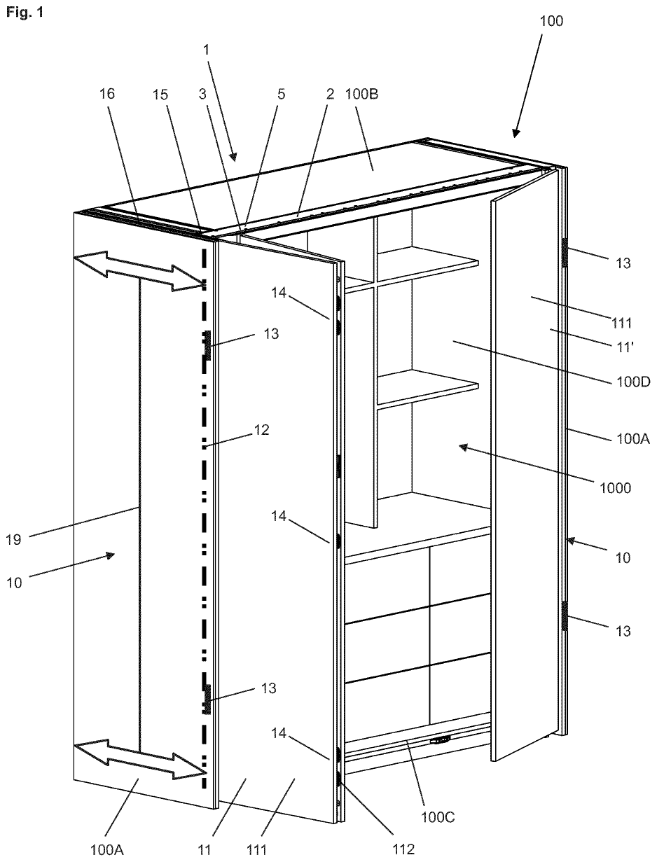

FIG. 1 an inventive functional entity 100 in the embodiment of a piece of furniture with a foldable sliding door 11 with a first door element 111 and a second door element 112, which are connected to each other by door hinges 14 and of which the second door element 112 is held by a guiding device 1 comprising a guide rail 2 and a guide carriage 5, which is connected to the front side of the second door element 112 by a connection device 3;

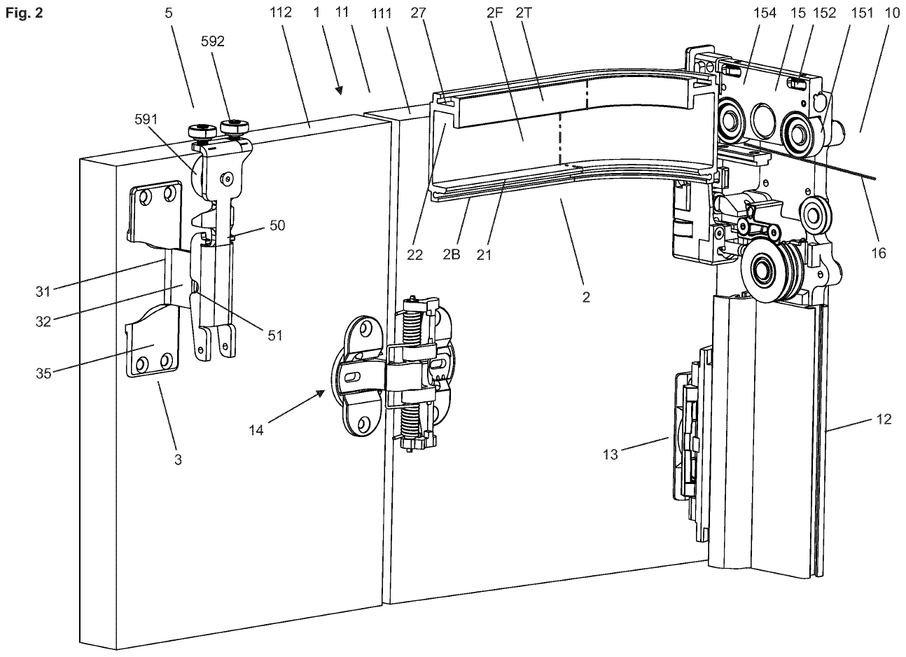

FIG. 2 the rear side of the folding door 11 of the functional entity 100 of FIG. 1 with the first door element 111, which is connected at the trailing edge by mounting hinges 13 to a mounting profile 12 and at the leading edge by door hinges 14 to the second door element 112, which is connected at the front side by a connection device 3 and a coupling device 51 to the guide carriage 5;

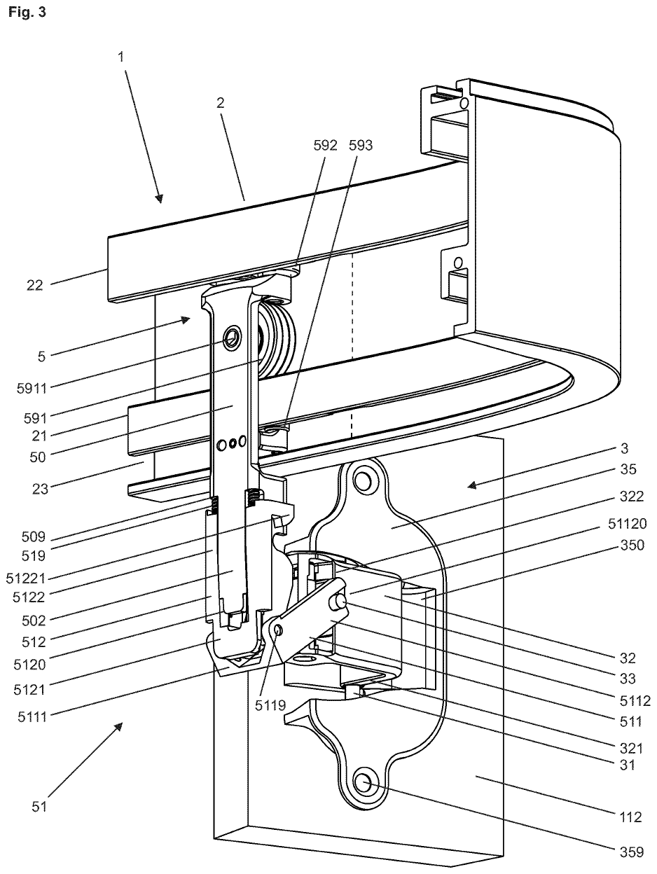

FIG. 3 the guiding device 1 of FIG. 2 in a preferred embodiment with the guide carriage 5, which is guided in the running rail 2 and comprises a coupling device 51, which can be coupled to the connection device 3 and the separation element 112;

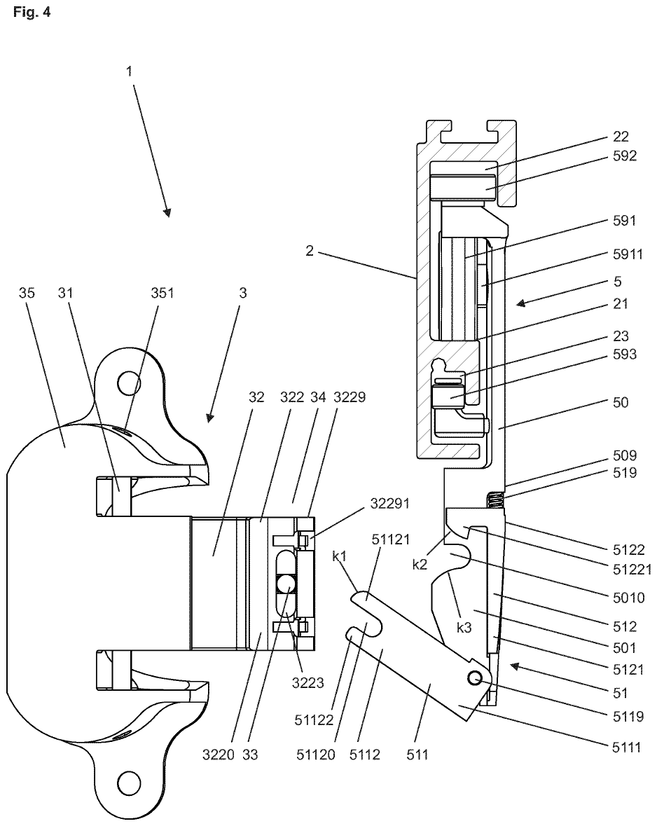

FIG. 4 the guiding device 1 of FIG. 3 with the connection device 3 detached from the coupling device 51 of the guide carriage 5 without the separation element 112;

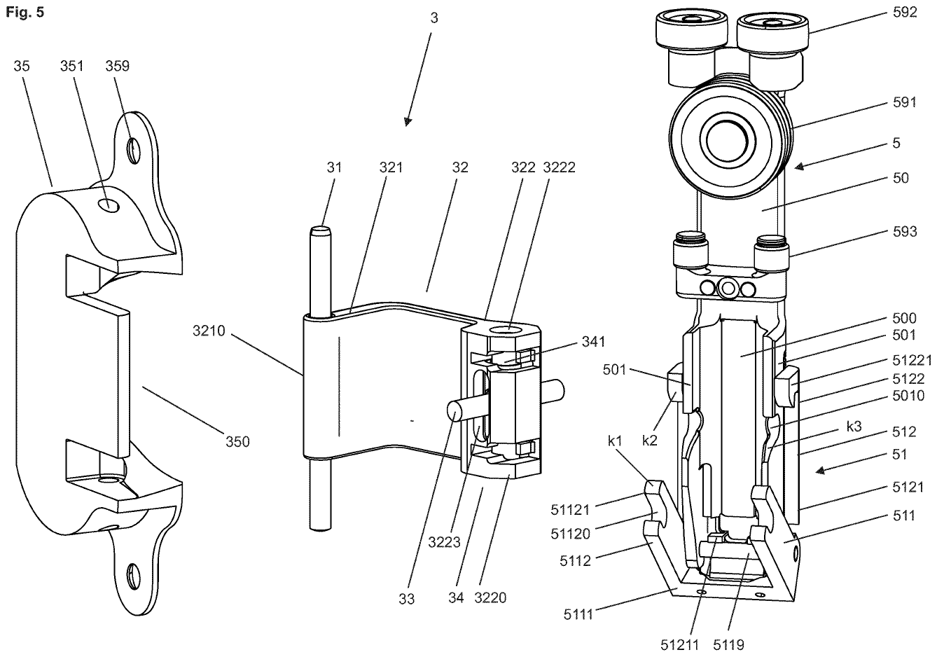

FIG. 5 the guide carriage 5 with the coupling device 51 of FIG. 4 and the connection device 3 detached therefrom, which comprises a hinge lever 32 and a hinge part 35 which has been detached from the hinge lever 32;

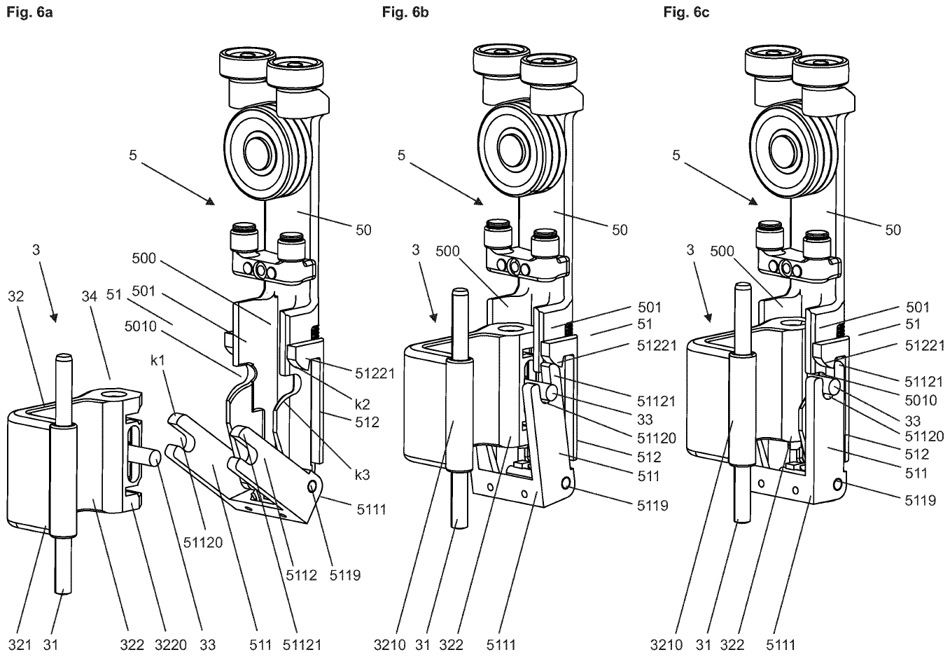

FIG. 6a the guide carriage 5 with the coupling device 51 of FIG. 4 and the connection device 3 detached from it without the hinge part 35;

FIG. 6b the guide carriage 5 with the coupling device 51 of FIG. 6a during the coupling of the connection device 3;

FIG. 6c the guide carriage 5 with the coupling device 51 of FIG. 6b after completion of the coupling of the connection device 3;

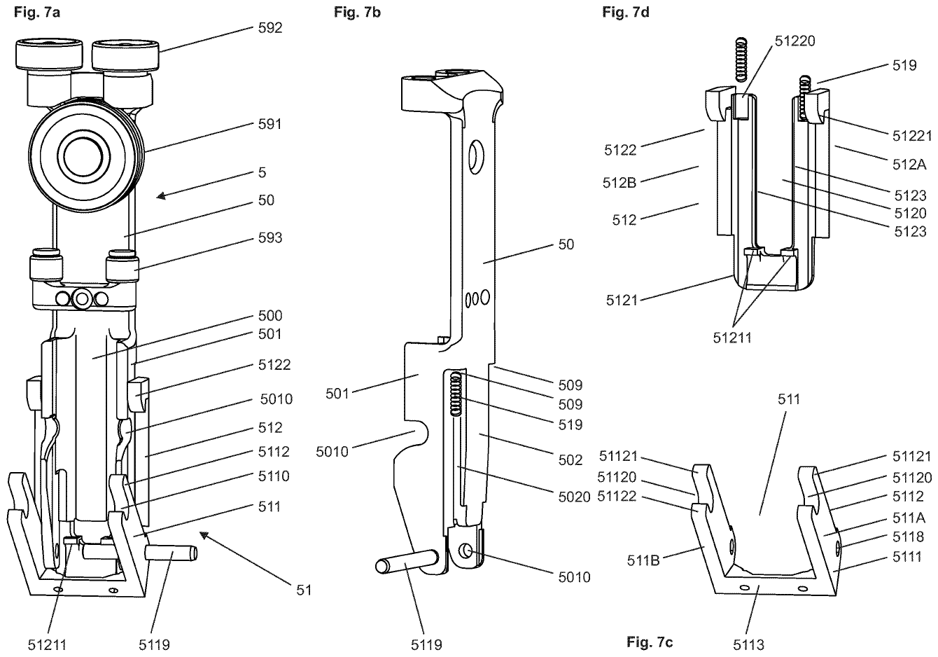

FIG. 7a the guide carriage 5 with the coupling device 51 of FIG. 4, which comprises a carriage body 50 which holds the support rollers 591, two guide rollers 592 and two stabilising rollers 593 as well as the coupling lever 511, which is rotatably mounted by means of a lever shaft 5119, and the holding sledge 512, which is displaceably mounted;

FIG. 7b the carriage body 50 of FIG. 7a detached from the guide carriage 5;

FIG. 7c the coupling lever 511 detached from the guide carriage 5;

FIG. 7d the holding sledge 512 detached from the guide carriage 5;

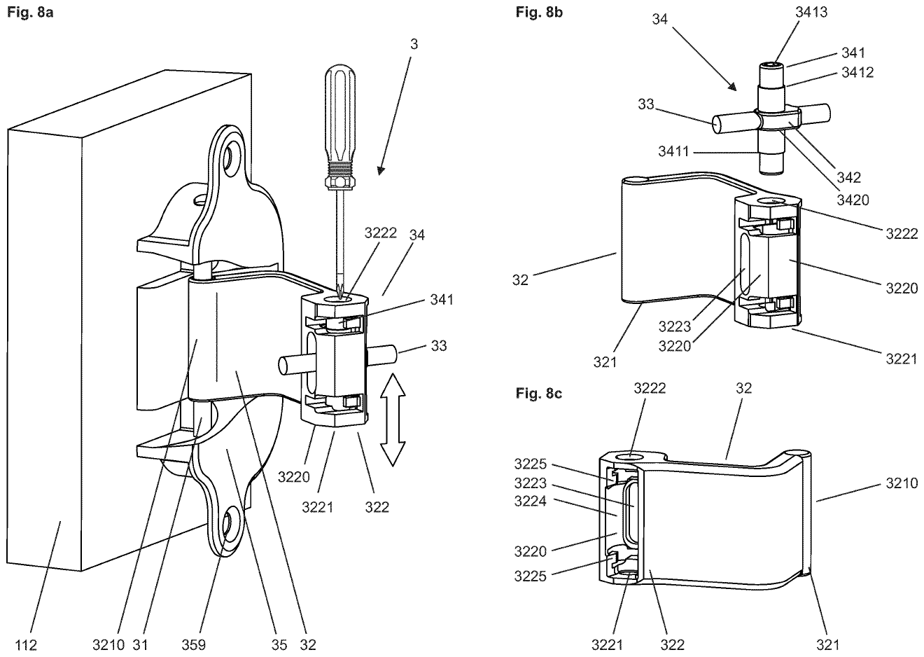

FIG. 8a the connection device 3 of FIG. 4 with the hinge lever 32, which comprises a hinge lever front piece 322 in the embodiment of a lever chamber 3220, in which an adjustment device 34 is arranged;

FIG. 8b the hinge lever 32 of FIG. 8a with the adjustment device 34 removed from the lever chamber 3220; and

FIG. 8c the hinge lever of FIG. 8b from the rear.

FIG. 1 shows an inventive functional entity 100 in the embodiment of a piece of furniture 100 with a foldable sliding door 11, which can be slid into a first door compartment 10, and with a one-piece door 11′, which can be slid into a second door compartment 10.

The piece of furniture 100 preferably comprises side walls 100A, an upper board 100B, a lower board 100C and partition walls 100D on both sides, which together with the side walls 100A delimit the door compartments 10.

The folding door 11 comprises a first separation element or door element 111, which is connected on one side by mounting hinges 13 to a mounting profile 12, and on the other side by door hinges 14 to a second separation element or door element 112, the dimensions of which preferably correspond to the dimensions of the first door element 111. The foldable sliding door 11 is slightly unfolded and can either be completely folded and retracted into the door compartment 10 with the door elements 111, 112 aligned parallel to one another or completely unfolded and moved into a closed position in which the two door elements 111, 112 are aligned at least approximately in one plane.

In the embodiment of FIG. 1, the mounting profile 12 is held by a displacement device 19, which is shown schematically, and is displaceable within the associated door compartment 10. The doors 11 are aligned in front of the associated door compartment 10 parallel to the side wall 100A and can subsequently be displaced into the door compartment 10. For displacement within the door compartment 10, each mounting profile 12 can also be provided with drive devices. Preferably, the mounting profile 12 is connected at the top to a support carriage 15, which can be moved into the door compartment along an associated support rail 16. On the underside, the mounting 10 profile 12 can also be connected to a carriage which is guided in a running rail.

The second door element 112 of the folding door 11 is connected at the leading edge to an inventive guiding device 1 comprising a guide carriage 5 with a coupling device 51, which is slidably mounted in a guide rail 2 and connected to the front side of the second door element 112 by a connection device 3 (see also FIG. 4).

The foldable sliding door 11 is therefore held at the front by means of the guide carriage 5, which can be moved along the front of the piece of furniture 100 when the foldable sliding door 11 is unfolded and into the door compartment 10 when the foldable sliding door 11 is folded. The guide carriage 5 runs ahead of the second door element 112 in the direction of displacement in each case.

FIG. 2 shows the rear side of the foldable sliding door 11 of the functional entity 100 of FIG. 1 with the first door element 111, which in this embodiment is connected at the trailing edge by mounting hinges 13 to the mounting profile 12 and at the leading edge by door hinges 14 to the second door element 112, whose front side is connected by the connection device 3 to the coupling device 51 of the guide carriage 5.

Also shown is the support carriage 15 connected to the mounting profile 12, which is displaceable along the support rail 16. The guide carriage 5 and the support carriage 15 are each provided with a carriage body 50, 154, with at least one support roller 591, 151 and preferably two guide rollers 592, 152.

The guide rail 2, in which the guide carriage 5 is guided, consists of a single rail section or several interconnected rail sections.

In this embodiment, the guide rail 2 comprises a front wall 2F, a head piece 2T and a foot piece 2B. A support body 21 is provided on the front wall 2F and a guide channel 22 is provided in the head piece 2T. The support body 21 serves for supporting the support rollers 591 and the guide channel 22 serves for guiding the guide rollers 592 of the guide carriage 5.

FIG. 3 shows the guiding device 1 with the coupling device 51 of FIG. 2 in a preferred embodiment with the guide carriage 5, which is guided in the running rail 2 and can be coupled to the separation element 112 by the connection device 3.

In this embodiment, the guide carriage 5 comprises, in addition to the support roller 591, which is held by a roller axle 5911 and rests against the support body 21, and the guide rollers 592, which are guided in the guide channel 22, additional stabilisation rollers 593, which are guided in a stabilisation channel 23. The carriage body 50 of the guide carriage 5 extends downwards with a lower part beyond the guide rail 2 and is provided on this lower part with the coupling device 51, which can be coupled to a connection device 3.

The coupling device 51 comprises a rotatably mounted coupling lever 511 with a coupling lever end piece 5111 and a coupling lever front piece 5112. The coupling lever end piece 5111 is rotatably connected to the carriage body 50 by a lever shaft 5119 and is rotatable between a receiving position and a locking position.

In FIG. 3, the coupling lever 511 is rotated forwards into the receiving position, in which a coupling rod 33 of the connection device 3 has been hooked into the coupling lever front piece 5112, which is fork-shaped for this purpose and comprises a receiving member 51120.

The coupling device 51 further comprises a displaceably mounted holding sledge 512 with a sledge end piece 5121 and a sledge front piece 5122. The holding sledge 512 is held by a sledge bearing 502 which is formed on the carriage body 50, which comprises a rectangular guide profile projecting into a correspondingly formed sledge opening 5120 and displaceably holds the holding sledge 512.

The rail end piece 5121 comprises retaining elements 51211 (see FIG. 5), which rest against the lever shaft 5119 in an end position and prevent the holding sledge 512 from being released from the carriage body 50.

The sledge front piece 5122 is provided with retaining hooks 51221, which face the connection device 3. Two return springs or recoil springs 519 are also provided between the sledge front piece 5122 and stop parts 509 of the carriage body 50, which push the holding sledge 512 into the end position against the lever shaft 5119.

The connection device 3 comprises a hinge lever 32 with a hinge lever end piece 321 and a hinge lever front piece 322. The hinge lever end piece 321 is rotatably connected to a hinge part or mounting part 35 by a hinge shaft 31. In this embodiment, the hinge part 35 comprises a lever opening 350 into which the hinge lever end piece 321 can be rotated. The hinge part 35 comprises mounting flanges with openings through which mounting screws (not shown) can be passed to connect the hinge part to the separation element 112.

The hinge part 35 is shown as a hinge cup, but can be of any design, for example a plate. The hinge part 35 is selected according to the type of separation element 112. For separation elements 112 made of wood, a hinge part 35 is preferably selected, which is designed as a hinge cup or as a mounting plate. If the separation element 112 is a glass plate, the hinge part 35 is preferably designed as a mounting plate.

The hinge lever front piece 322 holds the coupling rod 33, which has been hooked into the coupling lever front piece 5112.

FIG. 4 shows the guiding device 1 of FIG. 3 with the connection device 3 detached from the guide carriage 5 without the separation element 112. The guide rail 2 is shown from the front in a sectional view. The support roller 591 sits on the support body 21, the guide rollers 592 are guided in the guide channel 22 and the stabilisation rollers 593 are guided in the stabilisation channel 23.

Below the guide rail 2, the guide carriage 5 is provided with the coupling device 51, which has already been partially described with reference to FIG. 3. FIG. 4 now shows that the fork-shaped coupling lever front piece 5112 comprises a locking member 51121 and a holding member 51122, which delimit a receiving member 51120 with a receiving opening. The locking member 51121 comprises a locking shape k1 on the outside, which corresponds to a retaining shape k2 provided on the outside of the associated retaining hook 51221.

Furthermore, it is shown that the carriage body 50 is provided with a latching sink 5010, which is arranged at least approximately at the same or a slightly greater radial distance from the lever shaft 5119 as the receiving member or the receiving opening 51120. The latching sink 5010 comprises an entrance shape k3 on the underside, via which the coupling rod 33 can be inserted into the latching sink 5010 and is held there by the carriage body 50.

The latching sink 5010 is arranged on a side wall 501 of the carriage body 50, which preferably comprises two such side walls 501 with a latching sink 5010, which delimit a reception chamber 500 (see FIG. 5).

The connection device 3 already described with reference to FIG. 3 is shown in a position in which the coupling rod 33 is shown on the end face and aligned horizontally. The hinge shaft 31 is orientated vertically and therefore perpendicular to the coupling rod 33.

The hinge lever front piece 322 comprises a lever chamber 3220 in which an adjustment device 34 is provided, by means of which the coupling rod 33, which projects outwards on both sides through chamber openings 3223, 3224 (see FIG. 8c). At least one of the chamber openings 3223, 3224 is preferably designed in such a way that the coupling rod 33 is axially displaceable but not rotatable.

The lever chamber 3220 is preferably closed by a locking member 3229, which is removed to insert the adjustment device 34 and then reassembled by means of connecting elements 32291.

The hinge lever end piece 321, which is held by the hinge shaft 31, is covered by the hinge part or hinge cup 35. The hinge shaft 31 is held in bearing openings 351 provided in the hinge cup 35.

FIG. 5 shows the guide carriage 5 with the coupling device 51 of FIG. 4 and the connection device 3 detached therefrom, which comprises the hinge lever 32 and the hinge part 35, which has been detached from the hinge lever 32.

The guide carriage 5, which has already been described with reference to FIG. 3 and FIG. 4, is shown from the front. In this view, the reception chamber 500 is clearly visible, which is delimited on both sides by the side walls 501. The reception chamber 500 has a polygonal shape which corresponds to the shape of the hinge lever front piece 322 and comprises practically the same dimensions. The reception chamber 500 can thus receive and hold the hinge lever front piece 322 form-fittingly, so that the hinge lever front piece 322 can only perform an axial movement into the reception chamber 500 or out of the reception chamber 500 but cannot be rotated.

This illustration also shows the retaining elements 51211, which are provided on the sledge end piece 5121 and rest against the lever shaft 5119.

A lever sleeve 3210 is provided on the hinge lever end piece 321, by which the hinge shaft 31 is held.

A threaded rod 341 of the adjustment device 34 is inserted in the lever chamber 3220 of the hinge lever front piece 322, by means of which the coupling rod 33 can be moved downwards or upwards. The adjustment device 34 is described below with reference to FIG. 8b.

FIG. 6a shows the guide carriage 5 with the coupling device 51 of FIG. 5 with the connection device 3 detached therefrom without the hinge part 35. The locking shape k1 on the coupling lever front piece 5112 of the coupling lever 511, the retaining shape k2 on one of the retaining hooks 51221 of the holding sledge 512 and the entrance shape k3, via which the coupling rod 33 is inserted into the associated latching sink 5010, are labelled. In this embodiment, the guide carriage 5 with the coupling lever 511 and the holding sledge 512 is symmetrical, so that the coupling and locking processes are carried out on both sides with corresponding elements.

FIG. 6b shows the guide carriage 5 with the coupling device 51 of FIG. 6a during the coupling of the connection device 3. The coupling rod 33 has been hooked into the coupling lever 511 and the coupling lever 511 has been rotated against the carriage body so that the locking shape k1 (see FIG. 6a) of the coupling lever front piece 5112 or the locking member 51121 provided there is now in contact with the retaining shape k2 (see FIG. 6a) of the associated retaining hook 51221. In this position, the coupling rod 33 is already in contact with the entrance shape k3 (see FIG. 6a) of the latching sink 5010 and can be inserted into the latching sink 5010 in a controlled manner.

FIG. 6c shows the guide carriage 5 with the coupling device 51 of FIG. 6b after completion of the coupling of the connection device 3. The locking shape k1 (see FIG. 6a) was guided past the retaining shape k2 (see FIG. 6a) so that the holding sledge 512 was pushed back and the retaining hook 51221 could engage with the locking member 51121.

The coupling lever 511 is now blocked by the holding sledge 512 and can no longer rotate back. The hinge lever front piece 322 has been inserted into the reception chamber 500 and is held there form-fittingly between the side walls 501. The coupling rod 33 now rests preferably in the latching sinks 5010 against the carriage body 50.

The hinge lever 32 can only be released again from the guide carriage 5 if the holding sledge 512 is guided upwards and the retaining hook 51221 is released from the locking parts 51121. This requires a force to be applied to the holding sledge 512, which can be exerted directly manually, for example, or indirectly by applying force to the coupling lever 511 if the locking shape k1 and the retaining shape k2 have the appropriate embodiment, which is force-locking and not form-locking.

FIG. 7a shows the guide carriage 5 with the coupling device 51 of FIG. 4, which comprises a carriage body 50 that holds the support rollers 591, two guide rollers 592 and two stabilising rollers 593 as well as the coupling lever 511, which is rotatably mounted by means of a lever shaft 5119, and the holding sledge 512, which is displaceably mounted. By releasing the lever shaft 5119 from the carriage body 50, the coupling lever 511 and the holding sledge 12 can also be released from the carriage body 50.

FIG. 7b shows the carriage body 50 of FIG. 7a detached from the guide carriage 5 from the rear side with a view of the sledge bearing 502, which forms a guide profile to which the guide grooves 5020 adjoin. A return spring 519 is shown in the facing guide groove 5020, which rests against the top of a stop part 509 of the carriage body 50.

FIG. 7c shows the coupling lever 511 detached from the guide carriage 5, which comprises a U-profile with two identically designed lever arms 511A, 511B, each of which comprises a coupling lever front piece 5112 with a locking member 51121, a holding member 51122 and a receiving member 51120 in between. The two lever arms 511A, 511B, which are aligned parallel to each other, are connected to each other by a lever bridge 5113.

FIG. 7d shows the holding sledge 512 detached from the guide carriage 5, which comprises two sledge arms 512A, 512B aligned parallel to each other, which are each provided with a retaining hook 51221 and which delimit a sledge opening 5120. The sledge arms 512A, 512B comprise sledge runners 5123 directed towards each other, which engage in the guide grooves 5020 when the sledge bearing 502 in the form of a guide profile is inserted into the sledge opening 5120.

At the front, the sledge arms 512A, 512B are provided with retaining seats 51220 into which the reset springs 519 can be inserted. On the sledge end piece 5121, on the other hand, the retaining elements 51211 are provided.

FIG. 8a shows the connecting device 3 of FIG. 4 with the hinge lever 32, which comprises a hinge lever front piece 322 in the embodiment of a lever chamber 3220, which preferably has a polygonal cross-section, and in which an adjusting device 34 is arranged.

The adjusting device 34 comprises a threaded rod 341, which is rotatably mounted in the lever chamber 3220 by means of bearing elements. By rotating the threaded rod 341, for example by means of the screwdriver shown, which can be inserted into a tool connection 3413 at one end of the threaded rod 341, the coupling rod 33 can be moved upwards or downwards to adjust the height of the separating element 112. To insert the screwdriver into the tool connection 3413, the lever chamber 3220 comprises a lower access opening 3221 and/or an upper access opening 3222.

FIG. 8b shows the hinge lever 32 of FIG. 8a with the adjusting device 34 removed from the lever chamber 3220. The threaded rod 341 comprises a lower bearing shoulder 3411 and an upper bearing shoulder 3412, which is rotatably and axially non-displaceably mounted at both ends at the border of the access openings 3221, 3222 in bearing collars 3225 (see FIG. 8c). The threaded rod 341 is also rotatably held in a threaded bore of a bearing block 342. When the threaded rod 341 is rotated, the bearing block 341, which holds the coupling rod 33 or at least end pieces of the coupling rod 33, is moved upwards or downwards, while the threaded rod 341 is held axially non-displaceably by the lower bearing shoulder 3411 and/or the upper bearing shoulder 3412.

FIG. 8c shows the hinge lever 32 of FIG. 8b from the rear. It is shown that the facing second chamber opening 3224 of the lever chamber 3220 extends in height from the lower access opening 3221 to the upper access opening 3222, therefore the adjusting device 34 of FIG. 8b can be inserted into the lever chamber 3220 through the second chamber opening 3224. As described with reference to FIG. 4, a closure member may preferably be inserted into the second chamber opening 3224, comprising, for example, a chamber opening having the dimensions of the first chamber opening 3223.

List of references:

| | |
|---|---|
| 1 | guiding device |
| 10 | first or second door compartment or parking space |
| 100 | functional entity, piece of furniture, e.g. wardrobe |
| 100A | side walls |
| 100B | upper board |
| 100C | lower board |
| 100D | separation wall |
| 1000 | interior space of the functional entity 1 |
| 11 | foldable sliding door |
| 111 | first separation element or door element |
| 112 | second separation element or door element |
| 11′ | single part door |
| 12 | mounting profile |
| 13 | mounting hinges |
| 14 | door hinges |
| 15 | support carriage |
| 151 | support rollers of the support carriage |
| 152 | guide rollers of the support carriage |
| 154 | carriage body of the support carriage |
| 16 | support rail |
| 19 | displacement device |
| 2 | guide rail |
| 2B | foot piece |
| 2F | front wall |
| 2R | upper back piece |
| 2S | lower back piece |
| 2T | head piece |
| 21 | support body |
| 22 | guide channel |
| 23 | stabilisation channel |
| 3 | connection device |
| 31 | hinge shaft |
| 32 | hinge lever |
| 321 | hinge lever end piece |
| 3210 | lever sleeve |
| 322 | hinge lever front piece |
| 3220 | lever chamber |
| 3221 | lower access opening |
| 3222 | upper access opening |
| 3223 | first chamber opening |
| 3224 | second chamber opening |
| 3225 | bearing collar |
| 3229 | locking member |
| 32291 | connecting elements |
| 33 | coupling rod |
| 34 | adjustment device |
| 341 | threaded rod |
| 3411 | lower bearing shoulder |
| 3412 | upper bearing shoulder |
| 3413 | tool connection |
| 342 | bearing block |
| 3420 | threaded hole in the bearing block |
| 35 | hinge part, e.g. hinge cup |
| 350 | lever opening |
| 351 | bearing openings |
| 359 | mounting flanges |
| 5 | guide carriage |
| 50 | carriage body |
| 500 | reception chamber |
| 501 | side walls |
| 5010 | latching sink |
| 502 | sledge bearing, guide profile |
| 5020 | guide grooves |
| 509 | stop parts |
| 51 | coupling device |
| 511 | coupling lever |
| 511A, 511B | lever arms |
| 5111 | coupling lever end piece |
| 5112 | coupling lever front piece |
| 51120 | receiving member |
| 51121 | locking member |
| 51122 | holding member |
| 5113 | lever bridge |
| 5118 | lever bearing |
| 5119 | lever shaft |
| 512 | holding sledge |
| 512A, 512B | sledge arms |
| 5120 | sledge opening |
| 5121 | sledge end piece |
| 51211 | holding element |
| 5122 | sledge front piece |
| 51220 | reception seat |
| 51221 | retaining hook |
| 5123 | sledge runners |
| 519 | reset spring |
| 591 | support roller |
| 5911 | roller axle |
| 592 | guide rollers |
| 593 | stabilisation roller |
| k1 | locking shape |
| k2 | retaining shape |
| k3 | entrance shape |

1. A guiding device with a guide carriage, which comprises a carriage body and a coupling device connected to the carriage body, with a guide rail, in which the guide carriage is displaceably mounted, and with a connection device, which comprises a rotatably mounted hinge element, which is connectable to a separation element, and which is couplable to the guide carriage by the coupling device,
wherein the connection device comprises a hinge lever having a hinge lever end piece connected to the hinge element and a hinge lever front piece holding a coupling rod,
wherein the carriage body comprises a sledge bearing and holds a lever shaft,
wherein the coupling device comprises a coupling lever having a coupling lever end piece rotatably supported by the lever shaft and at least one coupling lever front piece having a locking member and a receiving member, which receiving member serves to receive and hold the coupling rod,
wherein the coupling device comprises a holding sledge, which is displaceably held by the sledge bearing, which is connected to the carriage body by at least one reset spring and which has at least one sledge front piece with a retaining hook,
wherein the locking member has a locking shape and the retaining hook has a retaining shape, and
wherein the coupling lever is dimensioned in such a way that when rotating the coupling lever into a locking position, the holding sledge is displaceable by interaction of the locking shape and the retaining shape and the coupling lever is lockable by the retaining hook.

2. The guiding device according to claim 1, wherein the carriage body has at least one latching sink, and when the coupling lever is rotated into the locking position, the coupling rod held in the receiving member is insertable into the latching sink, the holding sledge is displaceable by interaction of the locking shape and the retaining shape and the coupling lever is lockable by the retaining hook.

3. The guiding device according to claim 1, wherein the sledge end piece is provided with at least one holding element which, after insertion of the holding sledge into the sledge bearing and after insertion of the lever shaft, abuts against the lever shaft and prevents the holding sledge from detaching from the sledge bearing.

4. The guiding device according to claim 1, wherein the carriage body has a reception chamber, within which the hinge lever front piece of the mounted connection device is held in a form-fitting or force-fitting or form-fitting and force-fitting manner.

5. The guiding device according to claim 4, wherein the carriage body has two latching sinks, which serve to receive the coupling rod and the reception chamber has two side walls adjoining the carriage body, which are spaced apart from one another and in each of which one of the latching sinks is provided.

6. The guiding device according to claim 1, wherein the coupling lever comprises two lever arms spaced apart from one another, each with a coupling lever front piece which has a locking member and a receiving member, and the spacing of the lever arms is greater than the width of the carriage body or the width of the reception chamber.

7. The guiding device according to claim 6, wherein the holding sledge comprises two spaced-apart sledge arms each with a retaining hook, and the spacing of the lever arms is greater than the width of the carriage body or the width of the reception chamber, wherein the spacing of the lever arms corresponds to the spacing of the retaining hooks.

8. The guiding device according to claim 7, wherein the sledge arms are provided with sledge runners directed towards each other and the sledge bearing is designed as a guide profile, which has guide grooves running parallel to each other on both sides, into which the sledge runners engage.

9. The guiding device according to claim 7, wherein two reset springs are provided and the sledge arms are each provided at the front with a reception seat in which one of the reset springs is accommodated.

10. The guiding device according to claim 1, wherein the hinge lever front piece has a lever chamber in which the coupling rod is displaceably held by an adjustment device.

11. The guiding device according to claim 10, wherein:
the lever chamber has at least one access opening,
a threaded rod is rotatably held in the lever chamber,
the coupling rod is held by a bearing block in which a threaded bore is provided through which the threaded rod passes, and
the threaded rod comprises at least one tool connection which is accessible through the access opening, wherein the coupling rod projects on one side out of a first chamber opening and on the other side out of a second chamber opening of the lever chamber.

12. The guiding device according to claim 1, wherein the single part or two-part coupling rod is aligned perpendicular to the hinge axis and/or the coupling lever is rotatable from the locking position to a receiving position in which it rests against an abutment element of the carriage body.

13. The guiding device according to claim 1,
a) wherein the carriage body rotatably holds at least one support roller, which is supported on a support body of the guide rail and can roll thereon; or
b) wherein the carriage body rotatably holds at least one support roller which is supported on a support body of the guide rail and can roll thereon, and the carriage body rotatably holds at least one guide roller which engages in a guide channel of the guide rail; or
c) wherein the carriage body rotatably holds at least one support roller which is supported on a support body of the guide rail and can roll thereon, the carriage body rotatably holds at least one guide roller which engages in a guide channel of the guide rail, and the carriage body rotatably holds at least one stabilisation roller which engages in a stabilisation channel of the guide rail.

14. A guide carriage with a coupling device for a guiding device according to claim 1.

15. A functional entity with a guiding device according to claim 1.
